(19) United States
(12) Patent Application Publication
(10) Pub. No.: US 2025/0370698 A1
(43) Pub. Date: Dec. 4, 2025

(54) DISPLAY METHOD AND DISPLAY SYSTEM

(71) Applicant: SEIKO EPSON CORPORATION, Tokyo (JP)

(72) Inventor: Yusei MOTEGI, SAPPORO-SHI (JP)

(21) Appl. No.: 19/220,285

(22) Filed: May 28, 2025

(30) Foreign Application Priority Data
May 29, 2024 (JP) 2024-087330

(51) Int. Cl. G06F 3/14; H04N 21/44; H04N 21/4402

(52) U.S. Cl. CPC G06F 3/1462; H04N 21/44008; H04N 21/440245

(57) ABSTRACT

A display method includes: acquiring a master image; acquiring a first aspect ratio of a first display area, the first display area being an area in which a first image is displayed by a first display device; setting a first region in a master region of the master image based on the first aspect ratio; displaying, on the first display area, the first image obtained by cutting out an image portion inside the first region in the master image; acquiring a second aspect ratio of a second display area, the second display area being an area in which a second image is displayed by a second display device; setting, in the master region, a second region having an overlapping region that overlaps the first region and a non-overlapping region that does not overlap the first region in at least one of a first direction and a second direction that are orthogonal to each other in the master region, based on the second aspect ratio; displaying, on the second display area, the second image obtained by cutting out an image portion inside the second region; setting a positional relationship between the first region and the second region; and updating, when one of the first region and the second region is updated, the other region to maintain the positional relationship.

The present application is based on, and claims priority from JP Application Serial Number 2024-087330, filed May 29, 2024, the disclosure of which is hereby incorporated by reference herein in its entirety.

### BACKGROUND

### 1. Technical Field

The present disclosure relates to a display method and a display system.

### 2. Related Art

A system is known in which an image is supplied from a smartphone to a projector, and the projector projects the image (see, for example, JP-A-2017-97107).

JP-A-2017-97107 discloses that a smartphone and a projector are coupled to each other and, for example, Miracast (registered trademark) is coupled to a wireless communication interface.

JP-A-2017-97107 discloses that, in the projector, when the smartphone coupled to the projector is used in a so-called vertical direction and a digital micro-mirror device (DMD) is used in a normal use state, projection display of a projection image in which both sides in a horizontal direction are black stripes is performed on a screen.

In addition, JP-A-2017-97107 discloses that, in the projector, when receiving a notification that the smartphone coupled to the projector is used in the vertical direction, an aspect ratio of an image displayed on the smartphone is maintained by performing control of rotating a DMD by 90 degrees.

JP-A-2017-97107 is an example of the related art.

However, in the related art, when the projector is a device that does not have a mechanism for rotating the DMD by 90 degrees, the projection display of the projection image in which both sides in the horizontal direction are black stripes is performed on the screen by the projector, and thus a display region cannot be used to the maximum.

### SUMMARY

According to an aspect of the disclosure, there is provided a display method including: acquiring a master image; acquiring a first aspect ratio of a first display area, the first display area being an area in which a first image is displayed by a first display device; setting a first region in a master region of the master image based on the first aspect ratio; displaying, on the first display area, the first image obtained by cutting out an image portion inside the first region in the master image; acquiring a second aspect ratio of a second display area, the second display area being an area in which a second image is displayed by a second display device different from the first display device; setting, in the master region, a second region having an overlapping region that overlaps the first region and a non-overlapping region that does not overlap the first region in at least one of a first direction and a second direction that are orthogonal to each other in the master region, based on the second aspect ratio; displaying, on the second display area, the second image obtained by cutting out an image portion inside the second region in the master image; setting a positional relationship between the first region and the second region; and updating, when one of the first region and the second region is updated, the other region to maintain the positional relationship.

According to an aspect of the disclosure, there is provided a display system including: a first display device; and a second display device. The first display device acquires a master image, acquires a first aspect ratio of a first display area, the first display area being an area in which a first image is displayed by the first display device, and sets a first region in a master region of the master image based on the first aspect ratio, and displays, on the first display area, the first image obtained by cutting out an image portion inside the first region in the master image, the first display device or the second display device acquires a second aspect ratio of a second display area, the second display area being an area in which a second image is displayed by a second display device, and sets, in the master region, a second region having an overlapping region that overlaps the first region and a non-overlapping region that does not overlap the first region in at least one of a first direction and a second direction that are orthogonal to each other in the master region, based on the second aspect ratio, the second display device displays, on the second display area, the second image obtained by cutting out an image portion inside the second region in the master image, the first display device sets a positional relationship between the first region and the second region, and the first display device or the second display device updates, when an update is made to one of the first region and the second region, the other region to maintain the positional relationship.

### BRIEF DESCRIPTION OF THE DRAWINGS

FIG. 1 is a diagram showing a schematic configuration example of a display system according to an embodiment.

FIG. 2 is a diagram showing a schematic configuration example of a first display device according to the embodiment.

FIG. 3 is a diagram showing a schematic configuration example of a second display device according to the embodiment.

FIG. 4 is a diagram showing a schematic configuration example of a third display device according to the embodiment.

FIG. 5 is a diagram showing a schematic configuration example of a server device according to an embodiment.

FIG. 6 is a diagram showing an example of map information stored in the server device according to the embodiment.

FIG. 7 is a diagram showing a configuration example of a master layer in the first display device according to the embodiment.

FIG. 8A is a diagram showing an example of a first image displayed on a first display area of the first display device according to the embodiment.

FIG. 8B is a diagram showing an example of a second image displayed on a second display area of the second display device according to the embodiment.

FIG. 9 is a diagram showing an example of a procedure of processing performed in image display on the first display device according to the embodiment.

FIG. 10 is a diagram schematically illustrating a relationship between a first region of a screen of a sharing source device and a second region of a screen of a sharing destination device according to the embodiment.

FIG. 11A is a diagram showing an example of a center of a region according to the embodiment.

FIG. 11B is a diagram showing an example of the center of the region according to the embodiment.

FIG. 11C is a diagram showing an example of the center of the region according to the embodiment.

FIG. 12 is a diagram showing an example of an icon representing a positional relationship between the first region and the second region in a sharing destination image according to the embodiment.

FIG. 13 is a diagram showing an example of an icon representing the positional relationship between the first region and the second region in a sharing source image according to the embodiment.

FIG. 14 is a diagram showing an example of screen sharing according to the background art.

### DESCRIPTION OF EMBODIMENTS

An embodiment will now be described with reference to the drawings.

In the following description, dimensions of regions and the like illustrated in the drawings are examples for description, and are not necessarily strict dimensions, and are not necessarily limited to the illustrated dimensions.

In addition, in the drawings, when two or more overlapping line segments are illustrated, these line segments may be slightly shifted in order to make these line segments easy to see.

In addition, in the following description, a number, an alphabet, or a combination thereof may be added to a name of a component such as first or second, but this is for convenience of description and is not intended to limit disclosure contents to unnecessary.

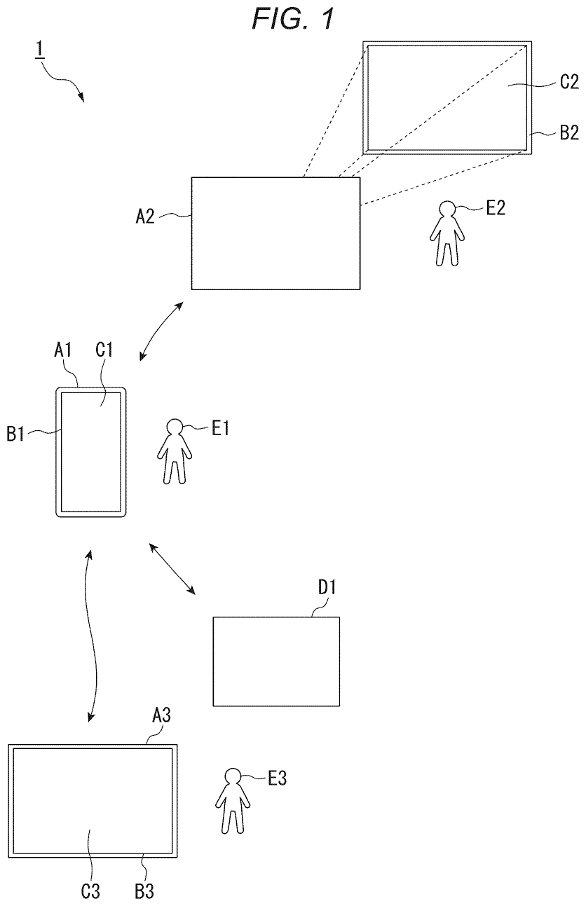

FIG. 1 is a diagram showing a schematic configuration example of a display system 1 according to an embodiment.

The display system 1 includes a first display device A1, a second display device A2, a third display device A3, and a server device D1.

FIG. 1 shows a first user E1 who operates the first display device A1, a second user E2 who operates the second display device A2, and a third user E3 who operates the third display device A3.

Here, in the embodiment, the server device D1 is described as being provided in the display system 1, but as another example, the server device D1 may be regarded as a device outside the display system 1.

In the embodiment, the display system 1 includes three display devices, but as another example, a display system having two display devices may be implemented, or a display system having four or more display devices may be implemented.

In the embodiment, the first display device A1 and the server device D1 communicate with each other by wire, wirelessly, or both.

In the embodiment, the first display device A1 and the second display device A2 communicate with each other by wire, wirelessly, or both.

In the embodiment, the first display device A1 and the third display device A3 communicate with each other by wire, wirelessly, or both.

In the embodiment, as a specific example, the first display device A1 is a smartphone, the second display device A2 is a projector, and the third display device A3 is a tablet terminal.

In the embodiment, the display system 1 including the first display device A1 to the third display device A3 is shown to describe a combination of the first display device A1, which is a smartphone as an example of a mobile terminal, and the second display device A2, which is a projector, and a combination of the first display device A1, which is a smartphone, and the third display device A3, which is a tablet terminal.

As another example, a display system including the first display device A1 as a smartphone and the second display device A2 as a projector may be implemented separately for each combination, or a display system including the first display device A1 as a smartphone and the third display device A3 as a tablet terminal may be implemented.

In the embodiment, a case in which each display device is operated by each user is shown, but as another example, two users among the first user E1 to the third user E3 may be common, or all the three users may be common.

For example, one or more display devices may automatically execute processing according to a predetermined processing procedure without being operated by the user.

The first display device A1 includes a first display area B1. In the example of FIG. 1, a first image C1 is displayed on the first display area B1.

The second display device A2 includes a second display area B2. In the example of FIG. 1, a second image C2 is displayed on the second display area B2. Here, in the embodiment, the second display device A2 is a projector, the second display area B2 is a screen, and the second image C2 is an image projected on the screen.

For example, the present disclosure may be applied to a case in which an image projected on the screen is viewed by a plurality of people in a predetermined room or the like.

The third display device A3 includes a third display area B3. In the example of FIG. 1, a third image C3 is displayed on the third display area B3.

In the embodiment, the image displayed on a display area may be an image of any display content, and may be, for example, an image representing a map, a sentence, a figure, a still image, a video, or a combination of two or more thereof.

Instead of the image, the image may be referred to as a video.

Here, a specific example of each display device is an example, and various devices may be used as each display device.

For example, a display device of a car navigation system or a display device of an electronic blackboard system may be used as the second display device A2 or the third display device A3.

For example, as the second display device A2 or the third display device A3, a display device having a screen and having a function of displaying an image input from the outside on the screen may be used.

The second display area B2 of the second display device A2 and the third display area B3 of the third display device A3 may be regarded as external monitors capable of screen sharing with respect to the first display area B1 of the first display device A1.

The screen sharing may be referred to as, for example, image sharing.

The display device may be referred to as, for example, an information processing device.

The server device D1 may be, for example, a cloud device.

In the embodiment, the first display device A1 communicates with the server device D1, but as another example, the second display device A2 or the third display device A3, or two or more display devices may communicate with the server device D1.

In the embodiment, in screen sharing, the first display device A1 is used as a sharing source device, and the second display device A2 or the third display device A3 is used as a sharing destination device.

Schematically, the first display device A1, which is the sharing source device, acquires image information from the server device D1 and displays an image based on the image information on its own display area. The first display device A1 transmits an image based on the image information to the sharing destination device as necessary. The second display device A2 or the third display device A3, which is the sharing destination device, displays the image on its own display area.

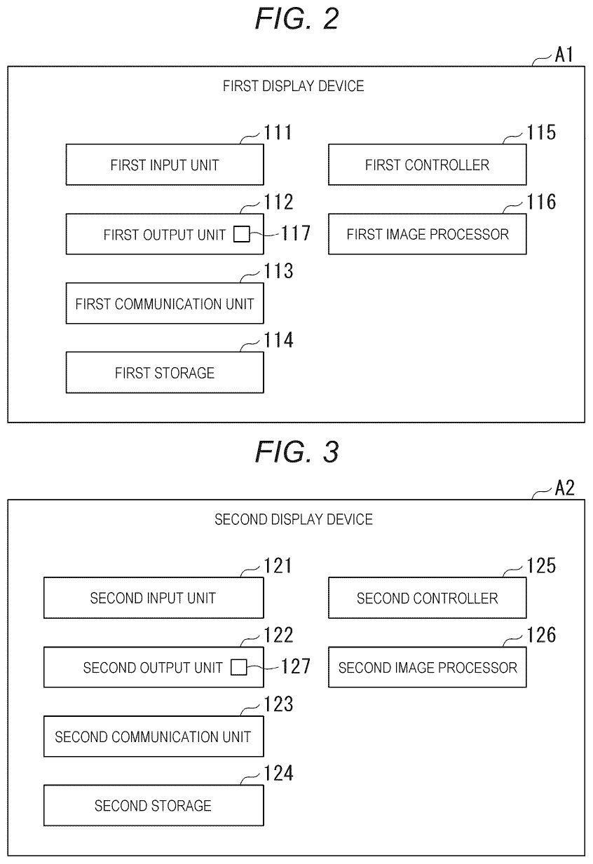

FIG. 2 is a diagram showing a schematic configuration example of the first display device A1 according to the embodiment.

The first display device A1 includes a first input unit 111, a first output unit 112, a first communication unit 113, a first storage 114, a first controller 115, and a first image processor 116.

The first output unit 112 includes a first display 117.

The first input unit 111 inputs information corresponding to an operation performed by the first user E1.

The first input unit 111 may input, for example, information output from an external device connected using a coupling terminal.

The first output unit 112 displays and outputs information on the first display area B1 by the first display 117. The first output unit 112 may output a sound together with the display of the image.

For example, the first output unit 112 may output information to an external device coupled using a coupling terminal.

Here, the first input unit 111 and the first display 117 may be implemented using, for example, a touch panel.

The first communication unit 113 communicates with an external device. In the embodiment, the external device is the second display device A2, the third display device A3, or the server device D1.

The first storage 114 stores various information.

The first controller 115 performs various types of processing and control in the first display device A1.

In the embodiment, the first display device A1 is implemented using a computer. The first controller 115 includes a processor such as a central processor (CPU) and performs various types of processing and control by executing a predetermined program by the processor.

The first image processor 116 performs various types of image processing. In the embodiment, for example, the first image processor 116 is controlled by the first controller 115 to perform various types of image processing.

Here, for example, the first display 117 displays and outputs an image processed by the first image processor 116.

FIG. 3 is a diagram showing a schematic configuration example of the second display device A2 according to the embodiment.

The second display device A2 includes a second input unit 121, a second output unit 122, a second communication unit 123, a second storage 124, a second controller 125, and a second image processor 126.

The second output unit 122 includes a second display 127.

The second input unit 121 inputs information corresponding to an operation performed by the second user E2. Here, the second input unit 121 may be implemented using, for example, a key or a touch panel.

The second output unit 122 displays and outputs information on the second display area B2 by the second display 127. The second output unit 122 may output a sound together with the display of the image.

The second communication unit 123 communicates with an external device. In the embodiment, the external device is the first display device A1.

The second storage 124 stores various information.

The second controller 125 performs various types of processing and control in the second display device A2.

In the embodiment, the second display device A2 includes a control computer. The second controller 125 includes a processor such as a CPU, and performs various types of processing and control by executing a predetermined program by the processor.

The second image processor 126 performs various types of image processing.

Here, in the embodiment, the second display device A2 is a projector.

The second image processor 126 includes, for example, a predetermined optical system and processes an image to be projected on the screen.

For example, the second display 127 outputs the image processed by the second image processor 126 to be displayed on the screen.

In the embodiment, for convenience of description, the second image processor 126 and the second display 127 are distinguished from each other, but for example, the second image processor 126 and the second display 127 may be integrated.

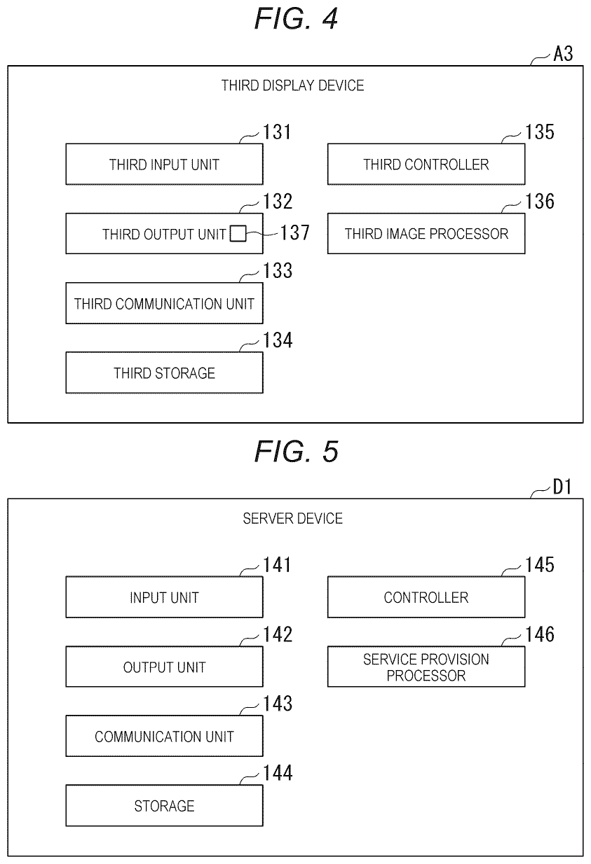

FIG. 4 is a diagram showing a schematic configuration example of the third display device A3 according to the embodiment.

The third display device A3 includes a third input unit 131, a third output unit 132, a third communication unit 133, a third storage 134, a third controller 135, and a third image processor 136.

The third output unit 132 includes a third display 137.

The third input unit 131 inputs information corresponding to an operation performed by the third user E3.

The third input unit 131 may receive, for example, information output from an external device coupled using a coupling terminal.

The third output unit 132 displays and outputs information on the third display area B3 by the third display 137. The third output unit 132 may output a sound together with the display of the image.

For example, the third output unit 132 may output information to an external device coupled using a coupling terminal.

Here, the third input unit 131 and the third display 137 may be implemented using, for example, a touch panel.

The third communication unit 133 communicates with an external device. In the embodiment, the external device is the first display device A1.

The third storage 134 stores various information.

The third controller 135 performs various types of processing and control in the third display device A3.

In the embodiment, the third display device A3 is implemented using a computer. The third controller 135 includes a processor such as a CPU, and performs various types of processing and control by executing a predetermined program by the processor.

The third image processor 136 performs various types of image processing. In the embodiment, for example, the third image processor 136 is controlled by the third controller 135 to perform various types of image processing.

Here, the third display 137 displays and outputs, for example, the image processed by the third image processor 136.

FIG. 5 is a diagram showing a schematic configuration example of the server device D1 according to the embodiment.

The server device D1 includes an input unit 141, an output unit 142, a communication unit 143, a storage 144, a controller 145, and a service provision processor 146.

The input unit 141 inputs information according to an operation performed by an operator (not shown).

The output unit 142 outputs information by display output, sound output, or the like.

The communication unit 143 communicates with an external device. In the embodiment, the external device is the first display device A1.

The storage 144 stores various information.

The controller 145 performs various types of processing and control in the server device D1.

In the embodiment, the server device D1 is implemented using a computer. The controller 145 includes a processor such as a CPU, and performs various types of processing and control by executing a predetermined program by the processor.

The service provision processor 146 performs processing for providing a predetermined service. In the embodiment, for example, the service provision processor 146 is controlled by the controller 145 to perform various types of image processing.

Here, in the embodiment, a case in which the service provision processor 146 of the server device D1 performs a service of providing predetermined map information will be described.

The map information is stored in, for example, the storage 144. As another example, the map information may be stored in a database or the like (not shown) provided outside the server device D1, and in this case, the server device D1 acquires the map information from the database or the like.

The information provided by the server device D1 is not particularly limited, and any other information may be used.

Here, in the embodiment, a case in which the server device D1 is operated by the operator is shown. However, for example, the server device D1 may be remotely operated by the operator.

As another example, the server device D1 may automatically perform predetermined processing without being operated by the operator.

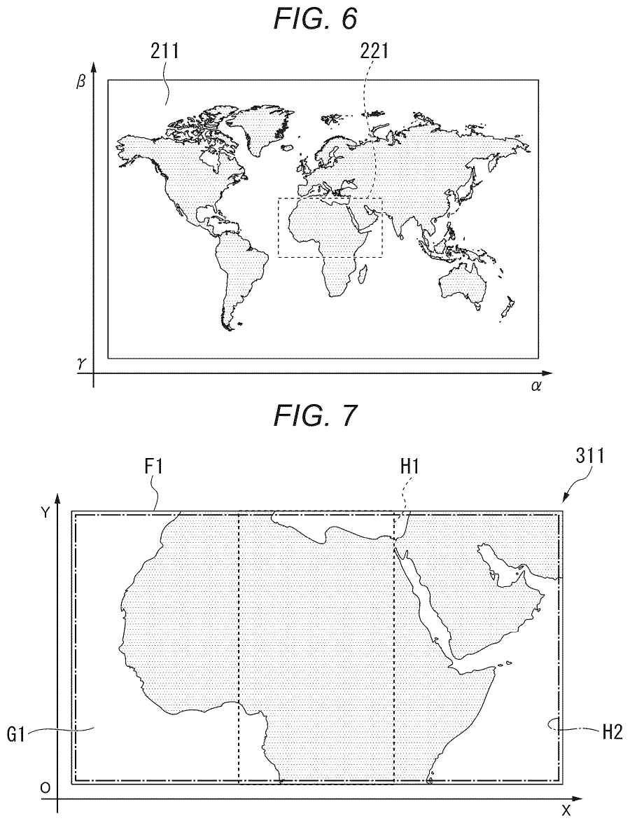

FIG. 6 is a diagram showing an example of map information 211 stored in the server device D1 according to the embodiment.

The map information 211 is, for example, information of a world map.

FIG. 6 shows an αβ orthogonal coordinate system, which is a two-dimensional orthogonal coordinate system, for convenience of description. In the αβ orthogonal coordinate system, an origin γ, an α axis, and a β axis are shown. In the embodiment, an α direction parallel to the α axis corresponds to a so-called horizontal direction, and a β direction parallel to the β axis corresponds to a so-called vertical direction.

FIG. 6 shows an example of the provision range 221 set in the map information 211.

The provision range 221 represents a range of an information portion provided to a provision destination by the service provision processor 146 in the entire map information 211.

In the embodiment, the provision destination is the first display device A1.

In the embodiment, the first display device A1 transmits request information to the server device D1 on a WEB site provided by the server device D1.

The service provision processor 146 of the server device D1 determines the provision range 221 based on the request information received from the first display device A1.

Then, the service provision processor 146 of the server device D1 transmits an information portion included in the determined provision range 221 in the map information 211 to the first display device A1.

Here, the first display device A1 changes the request information and transmits the request information to the server device D1 as necessary. By changing the request information from the first display device A1, the provision range 221 in the server device D1 is changed, and the information transmitted from the server device D1 to the first display device A1 is changed.

Screen sharing in a combination of the first display device A1 and the second display device A2 will be described with reference to FIGS. 7, 8A, 8B, and 9. In the embodiment, the first display device A1 is a main device, and the second display device A2 is a sub device.

FIG. 7 is a diagram showing a configuration example of a master layer 311 in the first display device A1 according to the embodiment.

FIG. 7 shows an XY orthogonal coordinate system, which is a two-dimensional orthogonal coordinate system, for convenience of description. In the XY orthogonal coordinate system, an origin O, an X axis, and a Y axis are shown.

In the embodiment, an X direction parallel to the X axis corresponds to a so-called horizontal direction, a positive side corresponds to the right side, and a negative side corresponds to the left side. In the embodiment, a Y direction parallel to the Y axis corresponds to a so-called vertical direction, a positive side corresponds to the upper side, and a negative side corresponds to the lower side. The horizontal direction and the vertical direction may be reversed.

Here, in the embodiment, the X direction and the Y direction in the XY orthogonal coordinate system are respectively parallel to the α direction and the β direction in the αβ orthogonal coordinate system shown in FIG. 6, but as another example, the X direction and the Y direction in the XY orthogonal coordinate system may be associated with the α direction and the β direction in the αβ orthogonal coordinate system shown in FIG. 6 in another aspect.

In the first display device A1, the first image processor 116 draws the master image on the master layer 311.

In the embodiment, a region of the master image is referred to as a master region.

In the example of FIG. 7, a first master image G1 is shown as the master image drawn on the master layer 311.

In the example of FIG. 7, a first master region μl is shown as the master region of the first master image G1.

Here, the master layer 311 may be, for example, a predetermined region provided in a recording region of the first storage 114. In this case, processing of drawing the master image in the master layer 311 may be processing of storing data of the master image in the master layer 311 and storing the master image.

In this case, for example, the master layer 311 and the first master region μl may be regarded as to be substantially the same.

In the example of FIG. 7, the first master region μl is a rectangular region surrounded by two line segments in the X direction parallel to the X axis and two line segments in the Y direction parallel to the Y axis. A square may be included as a type of rectangle.

In the example, the first image processor 116 of the first display device A1 transmits the request information to the server device D1 to acquire the information portion of the provision range 221 based on the request information from the server device D1. The information portion corresponds to the map information of the provision range 221. Then, the first image processor 116 of the first display device A1 draws the acquired map information on the master layer 311 as the first master image G1.

Here, in the embodiment, the request information includes information indicating a reference point and information indicating an aspect ratio.

The reference point is a point serving as a reference for setting the provision range 221 in the map information 211 in the server device D1, and may be, for example, a point serving as a center position of the provision range 221 in the map information 211.

The aspect ratio is used as a value for setting a frame of the provision range 221 with reference to the reference point.

Such information indicating the reference point may be regarded as coordinate information indicating coordinates of the content. Such a combination of the reference point and the aspect ratio may also be regarded as the coordinate information representing the coordinates and the range of the content. That is, the request information may be regarded as information including the coordinate information of the content.

The service provision processor 146 of the server device D1 determines and sets the provision range 221 suitable for the reference point and the aspect ratio designated by the request information from the first display device A1.

In the example, when one or both of the reference point and the aspect ratio identified by the request information change, the provision range 221 may change.

In the embodiment, the first image processor 116 of the first display device A1 determines the aspect ratio to be included in the request information based on the aspect ratio of the first display area B1 of the first display device A1 and the aspect ratio of the second display area B2 of the second display device A2.

In the example of FIG. 7, the first image processor 116 of the first display device A1 uses the aspect ratio of the second display area B2 of the second display device A2 as the aspect ratio to be included in the request information.

In the embodiment, the aspect ratio of the first display area B1 of the first display device A1 is (16:9) in (Y direction:X direction), and a resolution is (1920:1080).

In the embodiment, the aspect ratio of the second display area B2 of the second display device A2 is (9:16) in (Y direction:X direction) and (1080:1920) in resolution.

As described above, the aspect ratio of the first display area B1 is different from the aspect ratio of the second display area B2.

In the first display device A1, for example, the aspect ratio of the first display area B1 is stored in the first storage 114 in advance.

In the first display device A1, for example, the aspect ratio of the second display area B2 of the second display device A2 may be stored in advance in the first storage 114, or information identifying the aspect ratio of the second display area B2 of the second display device A2 may be acquired from the second display device A2 or another device. The another device may be the server device D1.

In the first display device A1, for example, the aspect ratio of the second display area B2 of the second display device A2 may be acquired from the second display device A2 or another device in real time during the screen sharing or the like.

In the example of FIG. 7, the first image processor 116 of the first display device A1 sets a first region H1 matching the aspect ratio of the first display area B1 of the first display device A1 in the first master region μl. Then, the first image processor 116 of the first display device A1 cuts out an image portion provided in the first region H1 and displays and outputs the image portion on the first display area B1.

In the example of FIG. 7, the first image processor 116 of the first display device A1 sets a second region H2 matching the aspect ratio of the second display area B2 of the second display device A2 in the first master region μl. Then, the first image processor 116 of the first display device A1 cuts out an image portion provided in the second region H2 and transmits the image portion to the second display device A2. Accordingly, the second image processor 126 of the second display device A2 displays and outputs the image portion on the second display area B2.

Here, the first region H1 may be associated with the master layer 311, the first master region μl, or the like using, for example, the coordinates in the XY orthogonal coordinate system.

The second region H2 may be associated with the master layer 311, the first master region μl, or the like using, for example, the coordinates in the XY orthogonal coordinate system.

The first region H1 and the second region H2 may be associated with each other using, for example, the coordinates in the XY orthogonal coordinate system, or may be associated with each other using a relative positional relationship.

In the example of FIG. 7, the second region H2 overlaps the first master region μl, but for convenience of description, the second region H2 and the first master region μl are slightly shifted from each other for easy viewing.

In the example of FIG. 7, an upper side and a lower side, which are parts of the first region H1, overlap the first master region μl.

In the embodiment, the second region H2 has an overlapping region that overlaps the first region H1.

In the embodiment, the second region H2 has a non-overlapping region that is a region not overlapping the first region H1 in the X direction, the Y direction, or both the X direction and the Y direction. That is, the second region H2 protrudes from the first region H1 in the X direction, the Y direction, or both the X direction and the Y direction.

In the embodiment, a case in which the first master region μl and the second region H2 coincide with each other is shown, and an aspect in which the first master region μl and the second region H2 do not coincide with each other may be used.

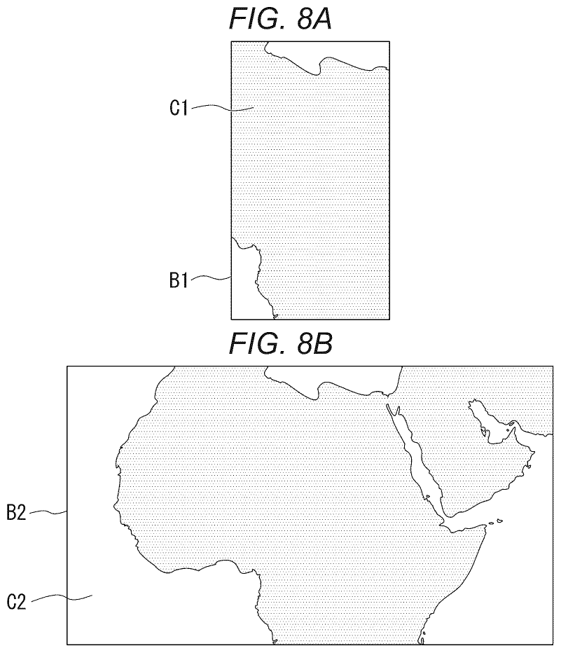

FIG. 8A is a diagram showing an example of the first image C1 displayed on the first display area B1 of the first display device A1 according to the embodiment.

FIG. 8B is a diagram showing an example of the second image C2 displayed on the second display area B2 of the second display device A2 according to the embodiment.

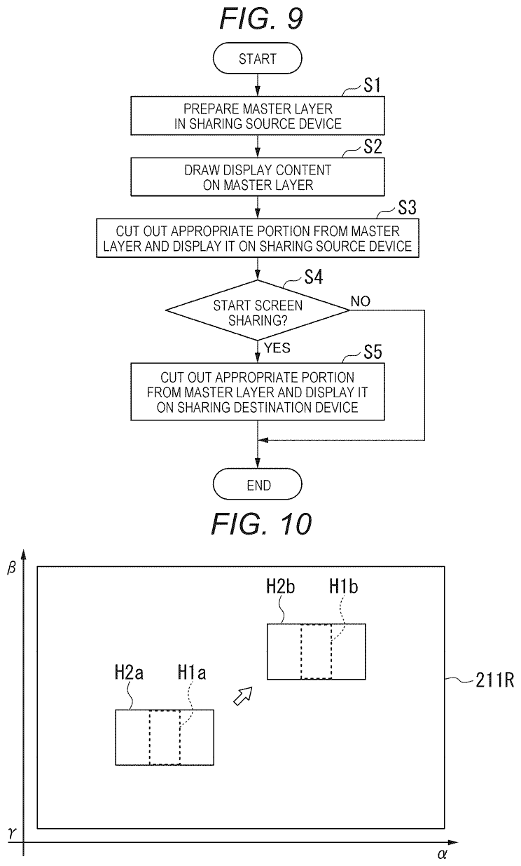

FIG. 9 is a diagram showing an example of a procedure of processing performed in image display in the first display device A1 according to the embodiment.

In the example, the sharing source device is the first display device A1, and the sharing destination device is the second display device A2.

In the example, the screen sharing is switched between ON and OFF in the first display device A1. The switching may be performed, for example, by the first user E1 operating the first display device A1, or may be automatically performed according to a predetermined switching condition.

In step S1, in the first display device A1 which is the sharing source device, the first image processor 116 prepares the master layer 311.

Next, in step S2, in the first display device A1, the first image processor 116 draws a display content on the master layer 311. In the example, the display content is the first master image G1.

Next, in step S3, in the first display device A1, the first image processor 116 cuts out an appropriate portion from the master layer 311 and displays an image of the portion on the first display area B1.

In the example, the appropriate portion is a portion of the first region H1.

Next, in step S4, in the first display device A1, the first image processor 116 determines whether to start the screen sharing.

In the example, the first image processor 116 determines to start the screen sharing when the screen sharing is already set to ON or when the screen sharing is switched from OFF to ON in real time. On the other hand, when the screen sharing is set to OFF, the first image processor 116 determines not to start the screen sharing.

In the determination of step S4, in the first display device A1, when the first image processor 116 determines to start the screen sharing, YES is determined in step S4, and the processing proceeds to step S5.

On the other hand, in the determination of step S4, in the first display device A1, when the first image processor 116 determines not to start the screen sharing, NO is determined in step S4, and the processing of the flow ends.

In step S5, in the first display device A1, the first image processor 116 performs processing for cutting out the appropriate portion from the master layer 311 and displaying an image of the portion on the second display area B2 of the second display device A2 which is the sharing destination device. The processing of the flow ends.

In the example, the appropriate portion is a portion of the second region H2.

As a specific example, when the first user E1 is viewing the first image C1 displayed on the first display area B1 of the first display device A1, the second user E2 can view the second image C2 displayed on the second display area B2 of the second display device A2. For example, a size of the second display area B2 of the second display device A2 is larger than a size of the first display area B1 of the first display device A1, and a plurality of users can simultaneously view the second image C2.

For example, when the first user E1 operates the first display device A1 to give an instruction to shift the reference point of the first region H1, the updated request information in which the reference point is shifted is transmitted from the first display device A1 to the server device D1. Accordingly, the provision range 221 in the server device D1 is updated, and the image portion transmitted from the server device D1 to the first display device A1 is updated. Then, the first master image G1 in the first display device A1 is updated, the image content of the first image C1 is updated, and the image content of the second image C2 is updated.

As an example, when the reference point of the map information displayed on the first display area B1 is shifted, the map information displayed on the first display area B1 is scrolled accordingly, and the map information displayed on the second display area B2 is scrolled in synchronization therewith.

As described above, in a display method and the display system 1 according to the embodiment, the first master image G1 of the first master region F1 is set based on the aspect ratio of the first display area B1 of the first display device A1 and the aspect ratio of the second display area B2 of the second display device A2.

Then, the first image C1 of the first region H1 corresponding to the aspect ratio of the first display area B1 is generated and displayed on the first display device A1.

The second image C2 of the second region H2 corresponding to the aspect ratio of the second display area B2 is generated and displayed on the second display device A2.

Therefore, in the display method and the display system 1 according to the embodiment, it is possible to optimally display the display content on the display area of each display device.

Here, in the example of FIG. 7, the first region H1 in the first master region F1 is a region that can be displayed to the maximum when the aspect ratio of the first display area B1 is used.

In the example of FIG. 7, the second region H2 in the first master region F1 is a region that can be displayed to the maximum when the aspect ratio of the second display area B2 is used.

As described above, in the display method and the display system 1 according to the embodiment, even when the aspect ratios of the display areas are different from each other, it is possible to eliminate a useless space when images are displayed on these display areas. The useless space is, for example, a black stripe portion in an example in the related art.

Here, the effect of the screen sharing in the embodiment will be described by comparison with an example in the related art.

In the screen sharing system according to the example in the related art, the display content of the display area of the sharing source device is generally copied as it is to the screen of another sharing destination device. In this case, in a configuration in which the aspect ratio of the sharing source and the aspect ratio of the sharing destination are different, a margin is generated in the display image of the sharing destination, and the margin becomes, for example, a black stripe portion (for example, see JP-A-2017-97107).

In the related art, software-controlled automatic scaling or cutting out is generally performed as a method for preventing a margin from being generated during the screen sharing.

However, the automatic scaling has a problem that screen distortion occurs or inappropriate scaling is performed.

In addition, during cutting out, since the cutting out is performed from the screen of the sharing source device, information at an end of the screen may be lost.

Here, a specific example of the screen sharing according to the background art will be described with reference to FIG. 14.

FIG. 14 is a diagram showing an example of the screen sharing according to the background art.

FIG. 14 shows an example of a second sharing source image 1011 displayed on the screen of the sharing source device and an example of a second sharing destination image 1021 displayed on the screen of the sharing destination device.

In the example of FIG. 14, for convenience of description, although a cutout region 1111 in the second sharing source image 1011 is shown, the cutout region 1111 is used in internal processing of the sharing source device but is not displayed on the screen.

In the example of FIG. 14, the cutout region 1111 is set in a central portion excluding an upper region and a lower region of the second sharing source image 1011. An image of a portion provided in the cutout region 1111 in the second sharing source image 1011 is the second sharing destination image 1021, but information of the upper region and the lower region is lost.

In the example of FIG. 14, a left side and a right side, which are parts of the cutout region 1111, overlap the region of the second sharing source image 1011.

Therefore, in the embodiment, a master region of a master image drawn in the master layer is optimized for the screen sharing between two devices having display areas with different aspect ratios. In the embodiment, the master region is designed to cover a widest image range when the screen sharing is performed between these two devices.

When the screen sharing is performed, a sharing source device serving as a transmission side cuts out an appropriate portion from the master layer based on its own aspect ratio, and displays the cutout portion on the screen. When the screen sharing is performed, the sharing source device serving as the transmission side cuts out an appropriate portion from the master layer based on the aspect ratio of the sharing destination device serving as a reception side, and transmits the cutout portion to the sharing destination device. Accordingly, the sharing destination device can receive the display content optimized for its own aspect ratio.

Therefore, in the embodiment, when the screen sharing is performed between two devices having display areas of different aspect ratios, information loss can be reduced and a margin can be eliminated as compared with the related art.

The embodiment is particularly effective for a display content whose aspect ratio is not fixed, for example.

Here, in the embodiment, a case in which the first master image G1 is changed by changing the request information transmitted from the first display device A1 to the server device D1 when a predetermined event occurs in the first display device A1 is described. The event is, for example, that the first user E1 performs a predetermined operation such as scrolling on the first display device A1 or that a predetermined automatic operation such as scrolling occurs in the first display device A1.

As another example, when a predetermined event occurs in the second display device A2, the second display device A2 may notify the first display device A1 of the occurrence of the event, and in response to this, the first display device A1 may change the request information transmitted to the server device D1, thereby changing the first master image G1. The event is, for example, that the second user E2 performs a predetermined operation such as scrolling on the second display device A2 or that a predetermined automatic operation such as scrolling occurs in the second display device A2. In this case, the notification from the second display device A2 to the first display device A1 is performed by transmitting predetermined information from the second display device A2 to the first display device A1.

In the embodiment, when the first display device A1 shares the screen with the second display device A2, the first display device A1 generates an image suitable for the aspect ratio of the second display area B2 of the second display device A2 based on the first master image G1 and transmits the generated image to the second display device A2.

As another example, when the first display device A1 shares the screen with the second display device A2, the first display device A1 may transmit an image corresponding to the first master image G1 to the second display device A2, generate an image suitable for the aspect ratio of the second display area B2 based on the image received by the second display device A2, and display the generated image. The generation processing includes, for example, setting and cutting out the second region H2.

The first display device A1 stores the aspect ratio of the first display area B1 in the first storage 114 or the like, and the second display device A2 stores the aspect ratio of the second display area B2 in the second storage 124 or the like.

In the embodiment, the first display device A1 acquires the first master image G1 based on the information received from the server device D1.

As another example, information serving as a source for generating the first master image G1 may be stored in a predetermined database, and the first display device A1 may acquire the first master image G1 based on the information.

As another example, information serving as a source for generating the first master image G1 may be stored in the first storage 114 of the first display device A1, and the first display device A1 may acquire the first master image G1 based on the information.

Although the screen sharing in the combination of the first display device A1 and the second display device A2 is described above, similar screen sharing may be applied to the combination of the first display device A1 and the third display device A3. In this case, for example, the first display device A1 is the main device, and the third display device A3 is the sub device.

Schematically, similar operations are performed by the third display device A3 and the third user E3 instead of the second display device A2 and the second user E2. However, in the embodiment, the second display device A2 is a projector, whereas the third display device A3 is a tablet terminal, and the operations may differ with respect to such differences.

A positional relationship between the first region of the screen of the sharing source device and the second region of the screen of the sharing destination device will be described with reference to FIG. 10.

FIG. 10 is a diagram schematically illustrating a relationship between the first region of the screen of the sharing source device and the second region of the screen of the sharing destination device according to the embodiment.

FIG. 10 shows a map region 211R that is a region of the map information 211 shown in FIG. 6.

In FIG. 10, for convenience of description, the αβ orthogonal coordinate system is shown as in the case of FIG. 6.

FIG. 10 also shows a 1a region H1a of the screen of the sharing source device and a 2a region H2a of the screen of the sharing destination device in a first state, and a 1b region H1b of the screen of the sharing source device and a 2b region H2b of the screen of the sharing destination device in a second state.

In the example of FIG. 10, for convenience of description, the 1a region H1a and the 2a region H2a, and the 1b region H1b and the 2b region H2b are shown overlapping the map region 211R.

In the example of FIG. 10, arrows indicating transitions from the 1a region H1a and the 2a region H2a to the 1b region H1b and the 2b region H2b are schematically shown to overlap the map region 211R.

In the example of FIG. 10, the upper side and the lower side, which are parts of the 1a region H1a, overlap the 2a region H2a, and the upper side and the lower side, which are parts of the 1b region H1b, overlap the 2b region H2b.

Here, the first state is a state in which the 1a region H1a is present at a first position in the map region 211R.

The second state is a state in which the 1a region Hla is moved from the first state and is present at a second position that is a position of the 1b region H1b in the map region 211R.

In the embodiment, a movement of the 1a region H1a from the first position to the second position, that is, transition from the first state to the second state occurs, for example, when a predetermined operation is performed on the sharing source device. As another example, the movement of the 1a region H1a from the first position to the second position, that is, the transition from the first state to the second state may occur when a predetermined operation is performed on the sharing destination device and the sharing destination device notifies the sharing source device of the fact.

As a specific example, a case in which the sharing source device is the first display device A1 which is a smartphone and the sharing destination device is the second display device A2 which is a projector will be described.

In the embodiment, the first image processor 116 of the first display device A1 sets the positional relationship between the 1a region H1a and the 2a region H2a. This setting may be performed, for example, in advance or at any timing. The content of the setting may be stored in, for example, the first storage 114.

Further, when the 1a region H1a is updated, the first image processor 116 updates the 2a region H2a, which is the other region, so as to maintain the set positional relationship.

In the example of FIG. 10, the 2a region H2a is moved to the 2b region H2b in response to the 1a region H1a being moved to the 1b region H1b. Accordingly, while the positional relationship between the 1a region H1a and the 2a region H2a is maintained, the processing proceeds to the 1b region H1b and the 2b region H2b.

That is, the combination of the 1a region H1a and the 2a region H2a is moved together while maintaining their relative positions.

Here, when the combination of the 1a region H1a and the 2a region H2a is moved, when the combination protrudes from a master region of the original master layer 311, a master image is updated according to the position of the combination of the 1a region H1a and the 2a region H2a in the sharing source device.

As another example, when there is an update related to the 2a region H2a, the second image processor 126 of the second display device A2 may notify the first image processor 116 of the first display device A1 of the update, and the first image processor 116 may perform an update related to the 1a region H1a, which is the other region, to maintain the set positional relationship.

In the example, the case in which the sharing destination device is the second display device A2 which is a projector is shown, and as another example, the present disclosure may be applied to a case in which the sharing destination device is the third display device A3 which is a tablet terminal.

As described above, in the display method and the display system 1 according to the embodiment, when the 1a region H1a is moved in the sharing source device, the 2a region H2a of the sharing destination device is also moved to follow the movement of the 1a region H1a, thereby updating the images of the 1a region H1a and the 2a region H2a. At this time, the master image is updated in the sharing source device as necessary.

Similarly, in the display method and the display system 1 according to the embodiment, when the 2a region H2a is moved in the sharing destination device, the 1a region H1a of the sharing source device is also moved to follow the movement of the 2a region H2a, and accordingly, the images of the 1a region H1a and the 2a region H2a are updated. At this time, the master image is updated in the sharing source device as necessary.

Therefore, in the display method and the display system 1 according to the embodiment, when the image of the 1a region H1a and the image of the 2a region H2a are displayed via the master layer 311, one region moves according to the movement of the other region, and the positional relationship between these regions is maintained.

Maintaining of the positional relationship between these regions corresponds to, for example, the positional relationship between these regions being unchanged.

As a specific example, when the master image is cut out and displayed on the smartphone and the projector, even when the image shown on the screen of the smartphone is updated, if the update is within the range of the master image, the image displayed by the projector is not updated.

Therefore, in the embodiment, the relative position between the display region of the smartphone and the display region of the projector is fixed, and when an image in one display region is updated, an image in the other display region is also updated in conjunction therewith.

Here, such a configuration is particularly effective, for example, when one of the sharing source device and the sharing destination device is capable of screen operation and the other is incapable of screen operation.

The sharing destination device may be a tablet terminal instead of the projector and the sharing source device may be a projector instead of the smartphone.

Here, the sharing source device or the sharing destination device may include a touch panel, and the touch panel may receive an input operation from the user.

The input operation is not particularly limited, and for example, a swipe operation, a pinch-out operation, a pinch-in operation, or a rotation operation may be used.

As a specific example, the user may be able to instruct enlargement or reduction with one hand by an operation of double-tapping and then swiping up and down.

The user may be able to instruct enlargement or reduction with both hands by performing a pinch-out or pinch-in operation.

The user may be able to instruct the rotation of the image by using two fingers to form the rotation.

The input operation is not limited to the example, and various operations may be used.

In the example of FIG. 10, the positional relationship between the 1a region H1a corresponding to the screen of the sharing source device and the 2a region H2a corresponding to the screen of the sharing destination device is maintained.

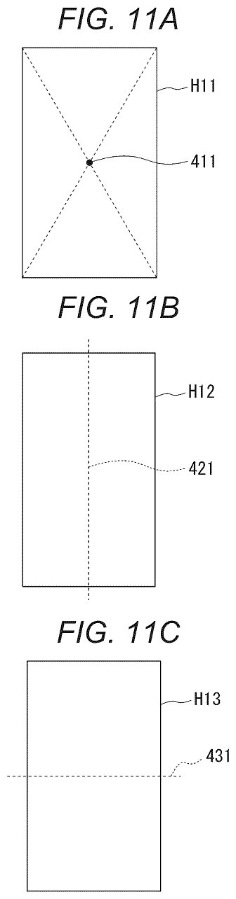

Here, an example of a center of the region will be described with reference to FIGS. 11A, 11B, and 11C.

FIG. 11A is a diagram showing an example of the center of the region according to the embodiment.

In the example of FIG. 11A, an intersection of two diagonal lines in a rectangular 11-th region H1l is defined as a first center point 411.

In FIG. 11A, for convenience of description, these two diagonal lines are also shown.

FIG. 11B is a diagram showing an example of the center of the region according to the embodiment.

In the example of FIG. 11B, for a rectangular 12-th region H12, a line parallel to the vertical direction drawn to bisect a width in the horizontal direction is defined as a first center line 421.

FIG. 11C is a diagram showing an example of the center of the region according to the embodiment.

In the example of FIG. 11C, for a rectangular 13-th region H13, a line parallel to the horizontal direction drawn to bisect a height in the vertical direction is defined as a second center line 431.

In the example of FIG. 10, when a center point as shown in FIG. 11A or a center line as shown in FIG. 11B or FIG. 11C is used as a reference, the centers of the 1a region Hla and the 2a region H2a coincide with each other.

The centers of the 1b region H1b and the 2b region H2b to which the 1a region H1a and the 2a region H2a are moved also coincide with each other.

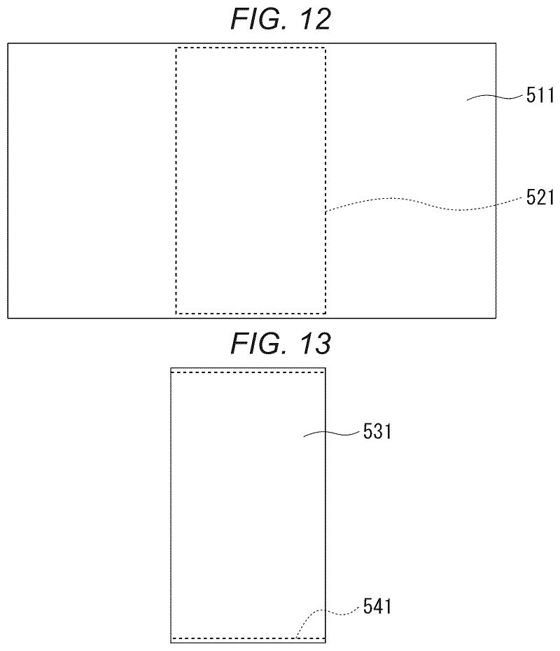

FIG. 12 is a diagram showing an example of an icon representing a positional relationship between the first region and the second region in a sharing destination image according to the embodiment.

FIG. 12 shows a first sharing destination image 511 that is an image displayed on the screen of the sharing destination device.

In the first sharing destination image 511, a first icon 521 indicating a positional relationship between the first region which is a region of the sharing source image which is an image displayed on the screen of the sharing source device and the second region which is a region of the first sharing destination image 511 is displayed in an overlapping manner. The display is performed based on information from the sharing source device in the sharing destination device, for example.

In the example of FIG. 12, the first icon 521 is information representing a boundary line corresponding to the first region in the second region of the first sharing destination image 511.

In the example, upper and lower sides of the first icon 521 overlap upper and lower sides of the second region of the first sharing destination image 511, and in the example of FIG. 12, for convenience of description, the upper and lower sides are slightly shifted from each other for easy viewing.

As another example, when the first region of the sharing source image and the second region of the first sharing destination image 511 partially or entirely overlap each other, as shown in FIG. 12, an aspect may be used in which the region of the first icon 521 is slightly shifted so that the first icon 521 does not overlap the second region of the first sharing destination image 511.

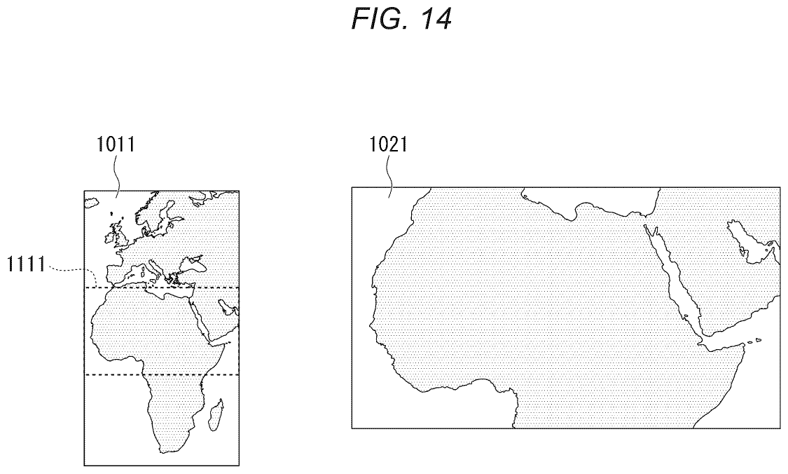

FIG. 13 is a diagram showing an example of an icon representing a positional relationship between the first region and the second region in the sharing source image according to the embodiment.

FIG. 13 shows a first sharing source image 531 that is an image displayed on the screen of the sharing source device.

In the first sharing source image 531, a second icon 541 indicating a positional relationship between a first region which is a region of the first sharing source image 531 and a second region which is a region of the sharing destination image which is an image displayed on the screen of the sharing destination device is displayed in an overlapping manner. The display is performed based on, for example, information of the sharing destination device in the sharing source device.

In the example of FIG. 13, the second icon 541 is information representing a boundary line corresponding to the second region in the first region of the first sharing source image 531. Specifically, the second icon 541 includes two linear marks representing the lower side and the upper side of the first region.

In the example, the upper and lower sides of the second icon 541 overlap the upper and lower sides of the first region of the first sharing source image 531, and in the example of FIG. 13, for convenience of description, the upper and lower sides are slightly shifted from each other for easy viewing.

As another example, when the first region of the first sharing source image 531 and the second region of the sharing destination image partially or entirely overlap each other, as shown in FIG. 13, an aspect may be used in which the region of the second icon 541 is slightly shifted so that the second icon 541 does not overlap the first region of the first sharing source image 531.

As an example, an aspect in which the first icon 521 is displayed in the first sharing destination image 511 as in the example of FIG. 12 and no icon is displayed in the sharing source image may be used.

As another example, the first icon 521 may be displayed on the first sharing destination image 511 as in the example of FIG. 12, and the second icon 541 may be displayed on the first sharing source image 531 as in the example of FIG. 13.

As a specific example, the sharing source device may be a smartphone, and the sharing destination device may be a tablet terminal.

Here, in the examples of FIGS. 12 and 13, the information indicating the boundary of the region on the other side is used as the icon indicating the positional relationship between the first region of the sharing source image and the second region of the sharing destination image, but other information may also be used. For example, information indicating a center point of the region on the other side may be used.

As an example, the display of the first icon in the sharing destination device may be implemented by the sharing source device generating an image including the first icon, supplying the image to the sharing destination device, and the sharing destination device displaying the image.

As another example, the display of the first icon in the sharing destination device may be implemented by the sharing source device supplying information identifying the first region to the sharing destination device, the sharing destination device generating an image based on information identifying its own second region and information from the sharing source device, and displaying the image.

In the display method according to the embodiment, the first master image G1 is acquired, the first aspect ratio of the first display area B1 of the first display device A1 is acquired, the first region H1 is set in the first master region F1 of the first master image G1 based on the first aspect ratio, and the first image C1 obtained by cutting out an image portion inside the first region H1 in the first master image G1 is displayed on the first display area B1.

In the display method according to the embodiment, the second aspect ratio of the second display area B2 of the second display device A2 different from the first display device A1 is acquired, the second region H2 having the overlapping region that overlaps the first region H1 and having the non-overlapping region that does not overlap the first region H1 in at least one of the first direction and the second direction orthogonal to each other in the first master region F1 is set in the first master region F1 based on the second aspect ratio, and the second image C2 in which the image portion inside the second region H2 in the first master image G1 is cut out is displayed on the second display area B2.

In the display method according to the embodiment, the positional relationship between the first region H1 and the second region H2 is set, and when one of the first region H1 and the second region H2 is updated, the other is updated to maintain the positional relationship.

Therefore, in the display method according to the embodiment, for example, by generating the first image C1 and the second image C2 from the first master image G1 instead of generating the second image from the first image, it is possible to display an image matching the aspect ratio of each of the first display area B1 and the second display area B2, and for example, it is possible to prevent both sides of the second image from being black images.

Further, in the display method according to the embodiment, for example, by setting the relative position between the first region H1 and the second region H2, when the first image C1 and the second image C2 are generated from the first master image G1, screen linkage can be achieved by a display content of the first display area B1 and a display content of the second display area B2.

Here, in the example of FIG. 7, the first direction is a direction parallel to the Y axis, and the second direction is a direction parallel to the X axis.

The positional relationship between the first region H1 and the second region H2 may be set using, for example, the coordinates of the first master image G1.

As an example, the coordinates of a first point in the first master image G1 may be associated with the coordinates of a point in the first region H1, and the coordinates of a second point in the first master image G1 may be associated with the coordinates of a point in the second region H2. Here, the first point and the second point may be the same point or may be different points.

As another example, the positional relationship between the first region H1 and the second region H2 may be set using the relative positional relationship between the first region H1 and the second region H2 without using the coordinates of the master image.

Here, a case in which the sharing source device is the first display device A1 and the sharing destination device is the second display device A2 is described as an example. For example, even when the sharing destination device is the third display device A3, the same effect can be obtained except for a difference that the second display device A2 is a projector and the third display device A3 is a tablet terminal.

In the display method according to the embodiment, as a configuration example, an operation of updating the first image C1 is received, and the second image C2 is updated based on the operation and the positional relationship.

Therefore, in the display method according to the embodiment, the screen linkage can be achieved by operating the first display device A1.

Such a configuration may not be used.

In the display method according to the embodiment, as a configuration example, an operation of updating the second image C2 is received, and the first image C1 is updated based on the operation and the positional relationship.

Therefore, in the display method according to the embodiment, the screen linkage can be achieved by operating the second display device A2.

In this case, for example, the second display device A2 notifies the first display device A1 of the content of the operation, and the first display device A1 updates the first master image G1 as necessary.

Such a configuration may not be used.

In the display method according to the embodiment, as a configuration example, the operation of updating the first image C1 or the operation of updating the second image C2 includes at least one of a swipe operation, a pinch-in operation, a pinch-out operation, or a rotation operation.

Therefore, in the display method according to the embodiment, when information such as a map is displayed, the user can perform an intuitive operation.

Such a configuration may not be used.

In the display method according to the embodiment, as a configuration example, the above-described positional relationship is a relationship in which the position of the first center point of the first region H1 and the position of the second center point of the second region H2 coincide with each other.

Therefore, in the display method according to the embodiment, the centers of the image displayed on the first display area B1 and the image displayed on the second display area B2 coincide with each other, and it is easy for the user to grasp the positional relationship between the first region H1 and the second region H2.

Such a configuration may not be used.

In the display method according to the embodiment, as a configuration example, the first positional relationship information representing the positional relationship described above is displayed in the second image C2.

Therefore, in the display method according to the embodiment, by displaying the first positional relationship information indicating the positional relationship between the first region H1 and the second region H2 in the second image C2, the user can easily grasp the correspondence relationship when comparing the first display area B1 and the second display area B2. Here, the first positional relationship information may be, for example, a predetermined icon.

Such a configuration may not be used.

In the display method according to the embodiment, as a configuration example, the second positional relationship information representing the positional relationship described above is displayed in the first image C1.

Therefore, in the display method according to the embodiment, by displaying the second positional relationship information indicating the positional relationship between the first region H1 and the second region H2 in the first image C1, it is possible for the user to easily grasp the correspondence relationship when comparing the first display area B1 and the second display area B2. Here, the second positional relationship information may be, for example, a predetermined icon.

Such a configuration may not be used.

In the display method according to the embodiment, as a configuration example, the above-described positional relationship is represented by relative position coordinates of the first region H1 and the second region H2.

Therefore, in the display method according to the embodiment, the positional relationship between the first region H1 and the second region H2 can be set using the coordinates of direct relative positions of both regions.

Such a configuration may not be used.

The display system 1 according to the embodiment can implement processing corresponding to various configurations of the display method according to the embodiment.

As a configuration example, the display system 1 according to the embodiment includes the first display device A1 and the second display device A2.

The first display device A1 acquires the first master image G1, acquires the first aspect ratio of the first display area B1 of the first display device A1, sets the first region H1 in the first master region F1 of the first master image G1 based on the first aspect ratio, and displays, on the first display area B1, the first image C1 obtained by cutting out an image portion inside the first region H1 in the first master image G1.

The first display device A1 or the second display device A2 acquires the second aspect ratio of the second display area B2 of the second display device A2, and sets, in the first master region F1, the second region H2 having an overlapping region that overlaps the first region H1 and having a non-overlapping region that does not overlap the first region H1 in at least one of the first direction and the second direction orthogonal to each other in the first master region F1, based on the second aspect ratio.

The second display device A2 displays, on the second display area B2, the second image C2 obtained by cutting out an image portion inside the second region H2 in the first master image G1.

The first display device A1 sets a positional relationship between the first region H1 and the second region H2.

When one of the first region H1 and the second region H2 is updated, the first display device A1 or the second display device A2 updates the other to maintain the positional relationship.

Therefore, in the display system 1 according to the embodiment, for example, by generating the first image C1 and the second image C2 from the first master image G1 instead of generating the second image from the first image, it is possible to display an image matching the aspect ratio of each of the first display area B1 and the second display area B2, and for example, it is possible to prevent both sides of the second image from being black images.

Further, in the display system 1 according to the embodiment, for example, by setting the relative positions of the first region H1 and the second region H2, when the first image C1 and the second image C2 are generated from the first master image G1, screen linkage can be achieved by a display content of the first display area B1 and a display content of the second display area B2.

Here, the acquisition of the second aspect ratio and the setting of the second region H2 based on the second aspect ratio may be performed by, for example, the first display device A1 or the second display device A2.

The processing of updating the first region H1 and the second region H2 to maintain the above-described positional relationship may be performed by, for example, the first display device A1.

In addition, in the processing of updating the first region H1 and the second region H2 to maintain the above-described positional relationship, for example, the processing of updating the first region H1 may be performed by the first display device A1, and the processing of updating the second region H2 may be performed by the second display device A2.

It is possible to record a program for implementing the function of any element in any apparatus described hereinabove on a computer-readable recording medium, and make a computer system read and then execute the program. The “computer system” mentioned here includes an operating system or hardware such as peripheral equipment. The “computer-readable recording medium” is a portable medium such as a flexible disk, a magneto-optical disk, a read only memory (ROM), or a compact disc (CD)-ROM, or a storage device such as a hard disk incorporated in the computer system. Further, the “computer-readable recording medium” includes what retains a program for a certain period of time such as a volatile memory located inside the computer system serving as a server or a client when the program is transmitted via a network such as the Internet or a communication line such as a telephone line. The volatile memory may be a RAM. The recording medium may be a non-transitory recording medium.

The program described above may be transmitted from a computer system in which the program is stored in a storage device or the like to another computer system via a transmission medium or by a transmission wave in the transmission medium. The “transmission medium” for transmitting the program refers to a medium including a function of transmitting information like a network such as the Internet or a communication line such as a telephone line.

The program described above may be a program for implementing a part of the functions described above. The program described above may be a so-called differential file that can achieve the function described above in combination with a program already recorded on the computer system. The differential file may be referred to as a differential program.

The function of any element in any apparatus described hereinabove may be implemented by a processor. Each processing in the embodiment may be implemented by a processor that operates based on the information such as a program and a computer-readable recording medium that stores the information such as a program. In the processor, the function of each unit may be implemented by individual hardware, or the function of each unit may be implemented by integrated hardware. The processor may include hardware, and the hardware may include at least one of a circuit that processes a digital signal and a circuit that processes an analog signal. The processor may be implemented using one or both of a single circuit device or a plurality of circuit devices mounted on a circuit board, and a single circuit element or a plurality of circuit elements. An integrated circuit (IC) or the like may be used as the circuit device, and a resistor, a capacitor, and so on may be used as the circuit element.

The processor may be a CPU. However, the processor is not limited to the CPU, and various processors such as a graphics processor (GPU) or a digital signal processor (DSP) may be used. The processor may be a hardware circuit using an application specific integrated circuit (ASIC). The processor may include a plurality of CPUs, or may include a hardware circuit including a plurality of ASICs. The processor may be implemented by a combination of a plurality of CPUs and a hardware circuit including a plurality of ASICs. The processor may include one or more of an amplifier circuit, a filter circuit, or the like that processes an analog signal.

While the embodiment is hereinabove described in detail with reference to the drawings, the specific configurations are not limited to the embodiment, and include designs and the like without departing from the scope of the present disclosure.

### Summary of Present Disclosure

A summary of the present disclosure will be appended below.

### APPENDIX 1

A display method includes:
acquiring a master image;
acquiring a first aspect ratio of a first display area, the first display area being an area in which a first image is displayed by a first display device;
setting a first region in a master region of the master image based on the first aspect ratio;
displaying, on the first display area, a first image obtained by cutting out an image portion inside the first region in the master image;
acquiring a second aspect ratio of a second display area, the second display area being an area in which a second image is displayed by a second display device different from the first display device;
setting, in the master region, a second region having an overlapping region that overlaps the first region and a non-overlapping region that does not overlap the first region in at least one of a first direction and a second direction that are orthogonal to each other in the master region, based on the second aspect ratio;
displaying, on the second display area, a second image obtained by cutting out an image portion inside the second region in the master image;
setting a positional relationship between the first region and the second region; and
updating, when one of the first region and the second region is updated, the other region to maintain the positional relationship.

Accordingly, for example, by generating the first image and the second image from the master image instead of generating the second image from the first image, it is possible to display an image matching the aspect ratio of each of the first display area and the second display area, and for example, it is possible to prevent both sides of the second image from being black images.

Further, by setting relative positions of the first region and the second region, when the first image and the second image are generated from the master image, screen linkage can be achieved by a display content of the first display area and a display content of the second display area.

### APPENDIX 2

The display method according to (Appendix 1), further includes: receiving an operation of updating the first image, and the second image is updated based on the operation and the positional relationship.

Accordingly, the screen linkage can be achieved by operating the first display device.

### APPENDIX 3

The display method according to (Appendix 1) or (Appendix 2), further includes: receiving an operation of updating the second image, and the first image is updated based on the operation and the positional relationship.

Accordingly, the screen linkage can be achieved by operating the second display device.

### APPENDIX 4

In the display method according to (Appendix 2) or (Appendix 3), the operation of updating the first image or the operation of updating the second image includes at least one of a swipe operation, a pinch-in operation, a pinch-out operation, and a rotation operation.

Accordingly, when displaying information such as a map, the user can perform an intuitive operation.

### APPENDIX 5

In the display method according to any one of (Appendix 1) to (Appendix 4), the positional relationship is a relationship in which a position of a first center point of the first region and a position of a second center point of the second region coincide with each other.

Accordingly, centers of the image displayed on the first display area and the image displayed on the second display area coincide with each other, and it is easy for the user to grasp the positional relationship between the first region and the second region.

### APPENDIX 6

The display method according to any one of (Appendix 1) to (Appendix 5), further includes: displaying first positional relationship information representing the positional relationship in the first image.

Accordingly, by displaying, in the second image, the first positional relationship information indicating the positional relationship between the first region and the second region, the user can easily grasp a correspondence relationship when comparing the first display area and the second display area. Here, the first positional relationship information may be, for example, a predetermined icon.

### APPENDIX 7

The display method according to any one of (Appendix 1) to (Appendix 6), further includes: displaying second positional relationship information representing the positional relationship in the first image.

Accordingly, by displaying, in the first image, the second positional relationship information indicating the positional relationship between the first region and the second region, the user can easily grasp a correspondence relationship when comparing the first display area and the second display area. Here, the second positional relationship information may be, for example, a predetermined icon.

### APPENDIX 8

In the display method according to any one of (Appendix 1) to (Appendix 7), the positional relationship is represented by relative position coordinates of the first region and the second region.

Accordingly, the positional relationship between the first region and the second region can be set using the coordinates of the direct relative positions of both regions.

### APPENDIX 9

A display system includes:
a first display device; and
a second display device,
the first display device
   acquires a master image,
   acquires a first aspect ratio of a first display area, the first display area being an area in which a first image is displayed by the first display device,
   sets a first region in a master region of the master image based on the first aspect ratio, and
   displays, on the first display area, a first image obtained by cutting out an image portion inside the first region in the master image,
the first display device or the second display device
   acquires a second aspect ratio of a second display area, the second display area being an area in which a second image is displayed by the second display device, and
   sets, in the master region, a second region having an overlapping region that overlaps the first region and a non-overlapping region that does not overlap the first region in at least one of a first direction and a second direction that are orthogonal to each other in the master region, based on the second aspect ratio,
the second display device displays, on the second display area, a second image obtained by cutting out an image portion inside the second region in the master image,
the first display device sets a positional relationship between the first region and the second region, and
the first display device or the second display device updates, when an update is made to one of the first region and the second region, the other region to maintain the positional relationship.

Accordingly, by generating the first image and the second image from the master image instead of generating the second image from the first image, it is possible to display an image matching the aspect ratio of each of the first display area and the second display area, and for example, it is possible to prevent both sides of the second image from being black images.

Further, for example, by setting relative positions of the first region and the second region, when the first image and the second image are generated from the master image, screen linkage can be achieved by a display content of the first display area and a display content of the second display area.

What is claimed is:

1. A display method comprising:
acquiring a master image;
acquiring a first aspect ratio of a first display area, the first display area being an area in which a first image is displayed by a first display device;
setting a first region in a master region of the master image based on the first aspect ratio;
displaying, on the first display area, the first image obtained by cutting out an image portion inside the first region in the master image;
acquiring a second aspect ratio of a second display area, the second display area being an area in which a second image is displayed by a second display device different from the first display device;
setting, in the master region, a second region having an overlapping region that overlaps the first region and a non-overlapping region that does not overlap the first region in at least one of a first direction and a second direction that are orthogonal to each other in the master region, based on the second aspect ratio;
displaying, on the second display area, the second image obtained by cutting out an image portion inside the second region in the master image;
setting a positional relationship between the first region and the second region; and
updating, when one of the first region and the second region is updated, the other region to maintain the positional relationship.

2. The display method according to claim 1, further comprising:
receiving an operation of updating the first image, wherein
the second image is updated based on the operation and the positional relationship.

3. The display method according to claim 1, further comprising:
receiving an operation of updating the second image, wherein
the first image is updated based on the operation and the positional relationship.

4. The display method according to claim 2, wherein
the operation of updating the first image or the operation of updating the second image includes at least one of a swipe operation, a pinch-in operation, a pinch-out operation, and a rotation operation.

5. The display method according to claim 1, wherein
the positional relationship is a relationship in which a position of a first center point of the first region and a position of a second center point of the second region coincide with each other.

6. The display method according to claim 1, further comprising:
displaying first positional relationship information representing the positional relationship in the second image.

7. The display method according to claim 6, further comprising:
displaying second positional relationship information representing the positional relationship in the first image.

8. The display method according to claim 1, wherein
the positional relationship is represented by relative position coordinates of the first region and the second region.

9. A display system comprising:
a first display device; and
a second display device, wherein
the first display device
acquires a master image,
acquires a first aspect ratio of a first display area, the first display area being an area in which a first image is displayed by the first display device,
sets a first region in a master region of the master image based on the first aspect ratio, and
displays, on the first display area, the first image obtained by cutting out an image portion inside the first region in the master image,
the first display device or the second display device
acquires a second aspect ratio of a second display area, the second display area being an area in which a second image is displayed by the second display device, and
sets, in the master region, a second region having an overlapping region that overlaps the first region and a non-overlapping region that does not overlap the first region in at least one of a first direction and a second direction that are orthogonal to each other in the master region, based on the second aspect ratio,
the second display device displays, on the second display area, the second image obtained by cutting out an image portion inside the second region in the master image,
the first display device sets a positional relationship between the first region and the second region, and
the first display device or the second display device updates, when an update is made to one of the first region and the second region, the other region to maintain the positional relationship.
